(19) United States
(12) Patent Application Publication
(10) Pub. No.: US 2024/0182232 A1
(43) Pub. Date: Jun. 6, 2024

(54) WARMER FOR GAS CANISTER

(71) Applicant: TREE & ROOT CO., LTD., Seoul (KR)

(72) Inventor: Gi Soo HAN, Jecheon-si (KR)

(21) Appl. No.: 18/061,315

(22) Filed: Dec. 2, 2022

(51) Int. Cl. B65D 83/72; F17C 13/08

(52) U.S. Cl. CPC B65D 83/72; F17C 13/084; F17C 2227/0316

(57) ABSTRACT

The present invention provides a warmer for a gas canister, the warmer including a casing having a curved surface corresponding to a bottom of a gas canister and having a structure with an open bottom, a magnet provided on an outer portion of the casing and configured to be attachable to the bottom of the gas canister, a heat generator provided in the casing and configured to transfer heat to the gas canister, and a bottom cover coupled to the bottom of the casing in a state in which the heat generator is mounted in the casing.

### TECHNICAL FIELD

The present invention relates to a warmer for a gas canister, which is capable of being used not only for a butane gas canister but also for an isobutane gas canister.

### BACKGROUND ART

In general, a butane gas is liquefied petroleum gas that contains butane as a main component. The butane gas is petroleum gas that is liquefied when the butane gas is pressurized at about 5 atm and at room temperature. The butane gas is commercially available as household fuel or camping fuel in a state in which the butane gas is pressurized and stored in a gas canister such as a small-scale bombe.

Isobutane gas is produced to have advantages of butane gas and propane gas. The isobutane gas is manufactured by mixing butane gas of 20% or less and propane gas 80% or more. The isobutane gas is gas that may be ignited even at −10 degrees.

A portable gas canister charged with butane gas and isobutane gas may be used for a hiking burner or a simple gas stove.

Because the portable gas canister is used in a state of being exposed to outside air, the gas stored in the gas canister is excessively condensed by a low ambient temperature in an environment such as the winter season in which the ambient temperature is low. For this reason, the gas cannot be easily vaporized and smoothly supplied.

The liquefied gas absorbs heat at the periphery thereof when the liquefied gas stored in the portable gas canister is supplied to a burner. For this reason, a temperature of the gas canister is rapidly lowered, and the gas stored in the gas canister is excessively condensed, which may cause an unstable supply of gas.

For this reason, there are problems in that the amount of gas discharged from the portable gas canister decreases, thermal power remarkably decreases, or the gas cannot be ignited even though gas remains in the gas canister.

However, a warmer for a gas canister in the related art has a large volume, which causes a problem in that a user is inconvenienced when carrying the warmer. In addition, the warmer for a gas canister in the related art does not have a separate device that may couple the warmer to gas canisters having different standards. For this reason, there are problems in that a butane gas canister and an isobutane gas canister, which have different shapes, cannot be used at the same time, and a warmer for a butane gas canister and a warmer for an isobutane gas canister need to be separately provided.

In contrast, the present invention is intended to provide a warmer for a gas canister, which is capable of being used not only for a butane gas canister but also for an isobutane gas canister and is small in volume, which makes it easy to carry the warmer.

### DOCUMENT OF RELATED ART

### Patent Document

(Patent Document 1) Korean Patent No. 10-1922975 (published on Nov. 28, 2018)

### SUMMARY OF THE INVENTION

The present invention has been made in an effort to solve the above-mentioned problems, and an object of the present invention is to provide a warmer for a gas canister, which is capable of being used not only for a butane gas canister but also for an isobutane gas canister and is small in volume, which makes it easy to carry the warmer.

To achieve the above-mentioned object, the present invention provides a warmer for a gas canister, the warmer including: a casing having a curved surface corresponding to a bottom of a gas canister and having a structure with an open bottom; a magnet provided on an outer portion of the casing and configured to be attachable to the bottom of the gas canister; a heat generator provided in the casing and configured to transfer heat to the gas canister; and a bottom cover coupled to the bottom of the casing in a state in which the heat generator is mounted in the casing.

A plurality of circular heat radiating fins may be provided on the outer portion of the casing and configured to define concentric circles, a radial heat radiating fin may be provided on the outer portion of the casing and intersect the circular heat radiating fins, and an accommodation space capable of accommodating a heating medium may be defined by a structure in which the radial heat radiating fin intersects the circular heat radiating fin.

The heat generator may include: a printed circuit board; a heater connected to the printed circuit board and configured to transfer heat to the casing; and a temperature sensor connected to the printed circuit board.

The heat generator may further include: a bimetal switch connected to the printed circuit board and spaced apart from the casing, and the bimetal switch may cut off a supply of power when a temperature of air in the casing is higher than a preset temperature.

The gas canister may be a first gas canister or a second gas canister, and the casing may be in close contact with a bottom of the first gas canister in a state in which a first cover is coupled, or the casing may be in close contact with a bottom of the second gas canister in a state in which a second cover is coupled.

The first gas canister may be a butane gas canister, the second gas canister may be an isobutane gas canister, and the first and second covers may each be a silicone cover.

A heating medium may be stored between a bottom of the first gas canister and the casing or stored between the bottom of the second gas canister and the casing.

The first cover may include: a ring-shaped main body configured to surround an edge of the casing and coupled to the bottom of the first gas canister so that an outer surface of the main body is in close contact with the bottom of the first gas canister to implement watertightness; and a handle extending from one side of the main body.

The second cover may include: a main body having a through-hole at a center thereof and configured such that the remaining portion of the main body, except for the through-hole, surrounds the casing, the main body having a curved surface corresponding to the bottom of the second gas canister; and a handle extending from one side of the main body.

The main body may have a plurality of stepped portions disposed between the through-hole and an edge of the main body and configured to define concentric circles having stepped shapes, and the stepped portion may be in close contact with the bottom of the second gas canister to implement watertightness.

According to the present invention, the warmer for a gas canister has a minimized volume that makes it easy to carry the warmer.

According to the present invention, the first cover may be coupled to the warmer for a gas canister, such that the warmer may be used for the butane gas canister.

According to the present invention, the second cover may be coupled to the warmer for a gas canister, such that the warmer may be used for the isobutane gas canister.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a casing according to an exemplary embodiment of the present invention.

FIG. 2 is a side view of the casing according to the exemplary embodiment of the present invention.

FIG. 3 is a top plan view of the casing according to the exemplary embodiment of the present invention.

FIG. 4 is a bottom plan view of the casing according to the exemplary embodiment of the present invention.

FIG. 5 is a cross-sectional view taken along line A-A in FIG. 3.

FIG. 6 is a view illustrating first and second gas canisters according to the exemplary embodiment of the present invention.

FIG. 7 is a perspective view of a first cover according to the exemplary embodiment of the present invention.

FIG. 8 is a top plan view of the first cover according to the exemplary embodiment of the present invention.

FIG. 9 is a cross-sectional view taken along line B-B in FIG. 8.

FIG. 10 is a view illustrating a state in which a warmer for a gas canister is coupled to a bottom of the first gas canister according to the exemplary embodiment of the present invention.

FIG. 11 is a perspective view of a second cover according to the exemplary embodiment of the present invention.

FIG. 12 is a top plan view of the second cover according to the exemplary embodiment of the present invention.

FIG. 13 is a cross-sectional view taken along line C-C in FIG. 12.

FIG. 14 is a view illustrating a state in which the warmer for a gas canister is coupled to a bottom of the second gas canister according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may of course be modified and variously carried out by those skilled in the art.

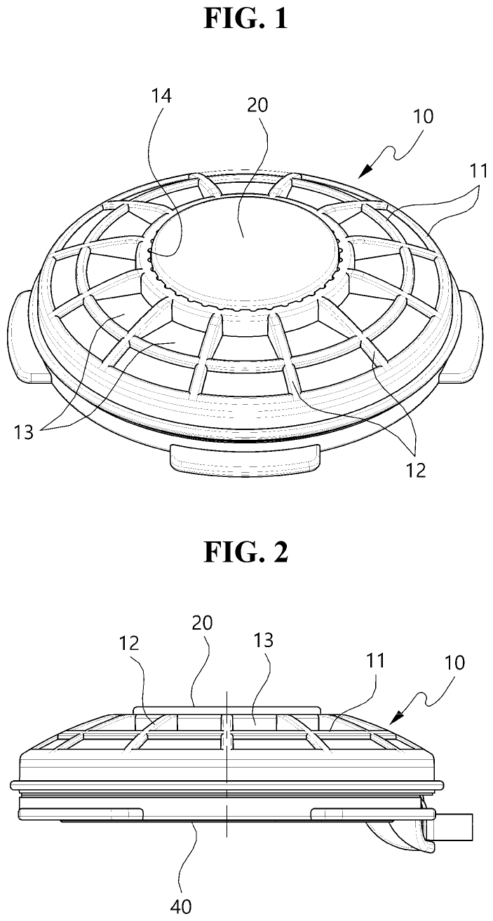

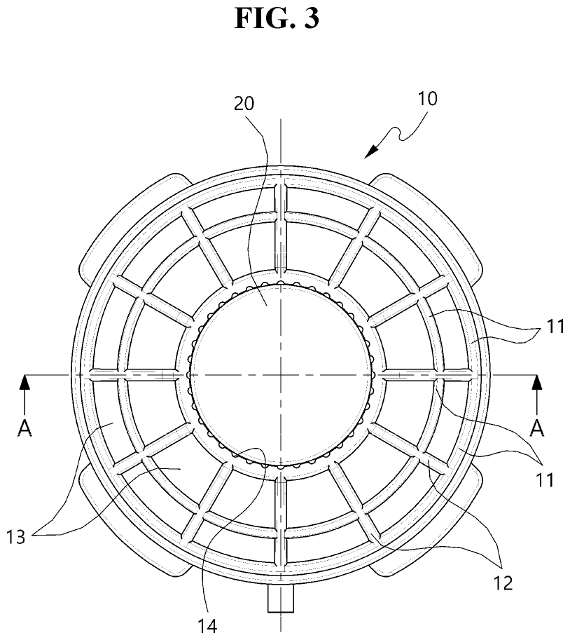

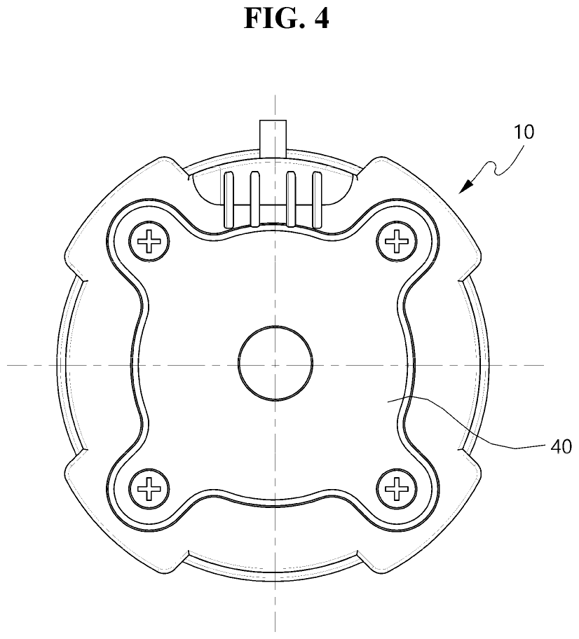

FIG. 1 is a perspective view of a casing according to an exemplary embodiment of the present invention, FIG. 2 is a side view of the casing according to the exemplary embodiment of the present invention, FIG. 3 is a top plan view of the casing according to the exemplary embodiment of the present invention, and FIG. 4 is a bottom plan view of the casing according to the exemplary embodiment of the present invention.

Referring to FIGS. 1 to 4, a warmer for a gas canister of the present invention includes a casing 10 made of metal capable of transferring heat, a magnet 20 provided on an outer portion of the casing 10, a heat generator 30 provided in the casing 10, and a bottom cover 40 coupled to a bottom of the casing 10. The bottom cover 40 may be coupled to the bottom of the casing 10 by a coupling member such as a bolt.

Specifically, a surface of the casing 10, which is directed toward a bottom of a gas canister, is formed as a curved surface corresponding to the bottom of the gas canister. A coupling space 14 is provided in an upper portion of the casing 10. The magnet 20 is coupled to the coupling space 14. The bottom of the casing 10 has an open structure that communicates with the inside of the casing 10. The heat generator 30 may be assembled by being inserted into the casing 10 through the bottom of the casing 10.

Heat radiating fins may be provided on the outer portion of the casing 10. The heat transferred from a heater 32 may be easily transferred to the gas canister by the heat radiating fins.

The heat radiating fins include circular heat radiating fins 11 and radial heat radiating fins 12. The circular heat radiating fins 11 are provided as a plurality of circular heat radiating fins 11 that defines concentric circles on the surface of the casing 10 that is directed toward the bottom of the gas canister. The radial heat radiating fins 12 intersect the circular heat radiating fins 11. Accommodation spaces 13 may be defined by the structure in which the circular heat radiating fins 11 intersect the radial heat radiating fins 12.

A liquid heating medium M such as water may be accommodated in the accommodation spaces 13. The heating medium M may be disposed between the gas canister and the casing 10 and maximize an effect of transferring heat of the casing 10 to the gas canister by maximizing a contact area between the casing 10 and the bottom of the gas canister.

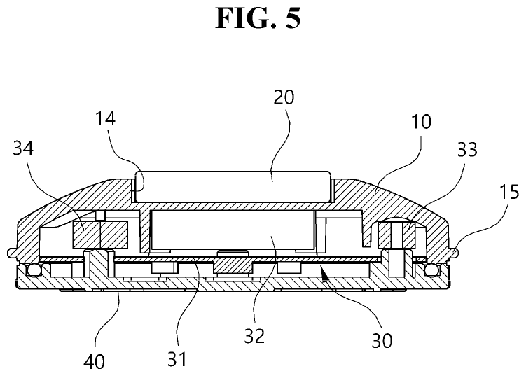

FIG. 5 is a cross-sectional view taken along line A-A in FIG. 3. Referring to FIG. 5, the heat generator 30 is assembled in the casing 10. The heat generator 30 includes a printed circuit board 31, the heater 32 electrically connected to the printed circuit board 31, a temperature sensor 33 electrically connected to the printed circuit board 31, and a bimetal switch 34 electrically connected to the printed circuit board 31.

The heater 32 generates heat and transfers the heat to the casing 10. The heat transferred to the casing 10 may be transferred to the gas canister. The temperature sensor 33 enables a temperature of the heater 32 to be maintained to be a preset temperature.

The bimetal switch 34 may be spaced apart from the casing 10 so as to detect a temperature of air in the casing 10. For example, the bimetal switch 34 is a safety device that cuts off a supply of power when a temperature of air in the casing 10 is higher than the preset temperature in the event of a breakdown of the warmer for a gas canister.

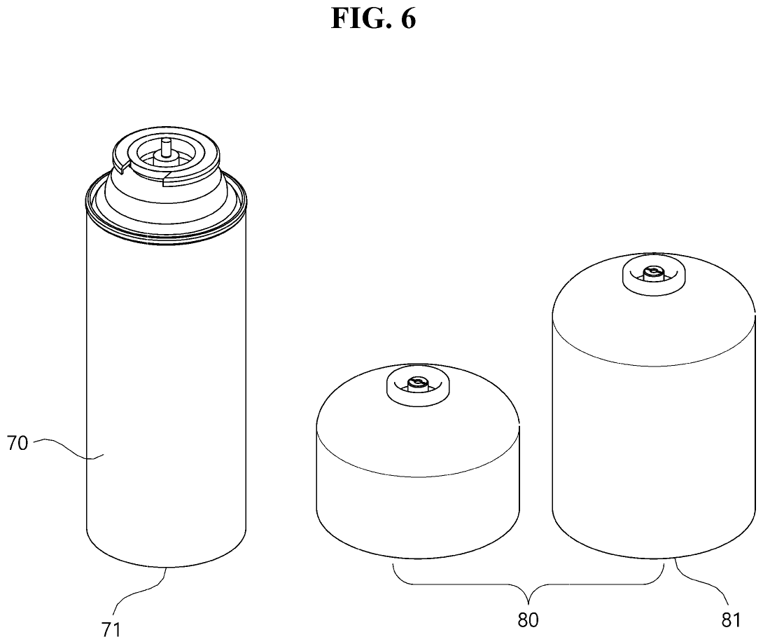

FIG. 6 is a view illustrating first and second gas canisters according to the exemplary embodiment of the present invention.

Referring to FIG. 6, the gas canister may be a first gas canister 70 or a second gas canister 80. The first gas canister 70 may be a butane gas canister, and the second gas canister 80 may be an isobutane gas canister.

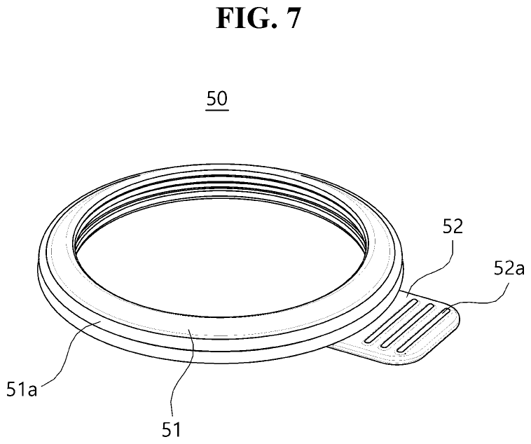

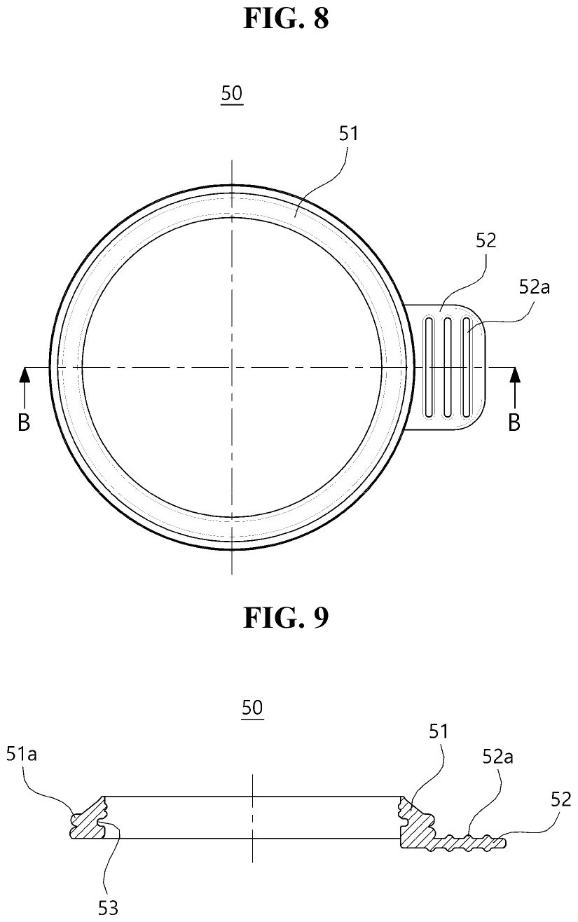

FIG. 7 is a perspective view of a first cover according to the exemplary embodiment of the present invention, FIG. 8 is a top plan view of the first cover according to the exemplary embodiment of the present invention, and FIG. 9 is a cross-sectional view taken along line B-B in FIG. 8.

Referring to FIGS. 8 and 9, the casing 10 may be in close contact with a bottom 71 of the first gas canister 70 in a state in which a first cover 50 is coupled. The heating medium M such as water may be stored between the bottom 71 of the first gas canister 70 and the casing 10.

The casing 10 may be in close contact with a bottom 81 of the second gas canister 80 in a state in which a second cover 60 is coupled. The heating medium M such as water may be stored between the bottom 81 of the second gas canister 80 and the casing 10.

For example, the first and second covers 50 and 60 may each be configured as a silicone cover having excellent elasticity.

The first cover 50 is a cover dedicated for the first gas canister 70. The first cover 50 includes a main body 51 and a handle 52. The main body 51 may have a ring shape. The main body 51 may have a ring shape and surround an edge of the casing 10. When the main body 51 is coupled to the bottom 71 of the first gas canister 70, an outer surface of the main body 51 is in close contact with the bottom 71 of the first gas canister 70, such that watertightness may be implemented. A lateral protrusion 51a may be provided on an outer surface of the main body 51. The lateral protrusion 51a is in close contact with the bottom 71 of the first gas canister 70 to maximize the watertightness effect.

The handle 52 may extend outward from one side of the main body 51 so that a user may easily pull the handle 52. Friction protrusions 52a may be provided on the handle 52 to prevent slippage.

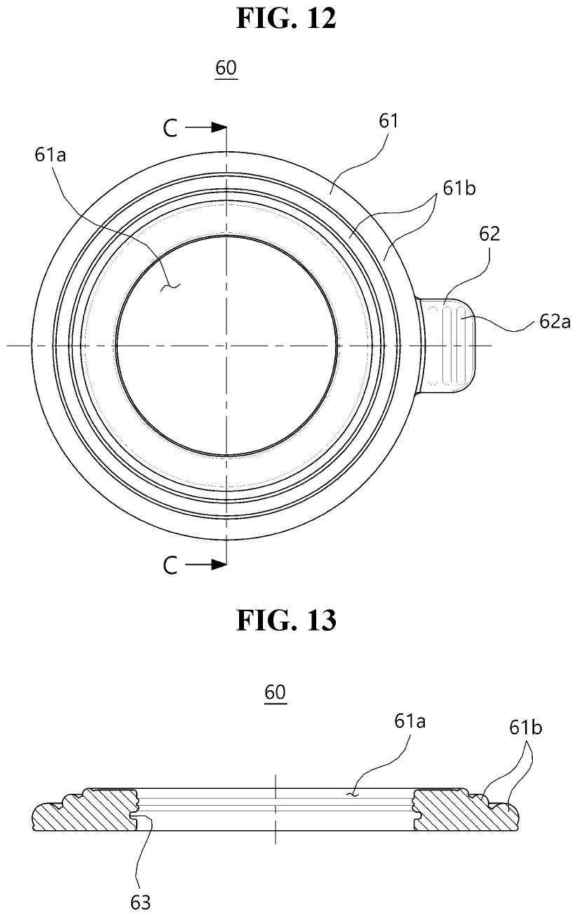

FIG. 11 is a perspective view of a second cover according to the exemplary embodiment of the present invention, FIG. 12 is a top plan view of the second cover according to the exemplary embodiment of the present invention, and FIG. 13 is a cross-sectional view taken along line C-C in FIG. 12.

Referring to FIGS. 11 to 13, the second cover 80 is a cover dedicated for the second gas canister 80. The second cover 80 includes a main body 61 and a handle 62. The main body 61 includes a through-hole 61a and stepped portions 61b. The remaining portion of the main body 61, except for the through-hole 61a, may surround the casing 10. The main body 61 may have a curved surface corresponding to the bottom 81 of the second gas canister 80. The through-hole 61a may be provided at a center of the main body 61. The through-hole 61a may be larger than the magnet 20.

The stepped portions 61b are provided as a plurality of stepped portions 61b. The stepped portions 61b may be disposed between the through-hole 61a and an edge of the main body 61 and define concentric circles having stepped shapes. The plurality of stepped portions 61b may be configured such that any one of the plurality of stepped portions 61b is in close contact with the bottom 81 of the second gas canister 80 regardless of a size of the bottom 81 of the second gas canister 80, thereby implementing watertightness.

The handle 62 may extend outward from one side of the main body 61 so that the user may easily pull the handle 62. Friction protrusions 62a may be provided on the handle 62 to prevent slippage.

Next, an operation of the first cover of the present invention will be described.

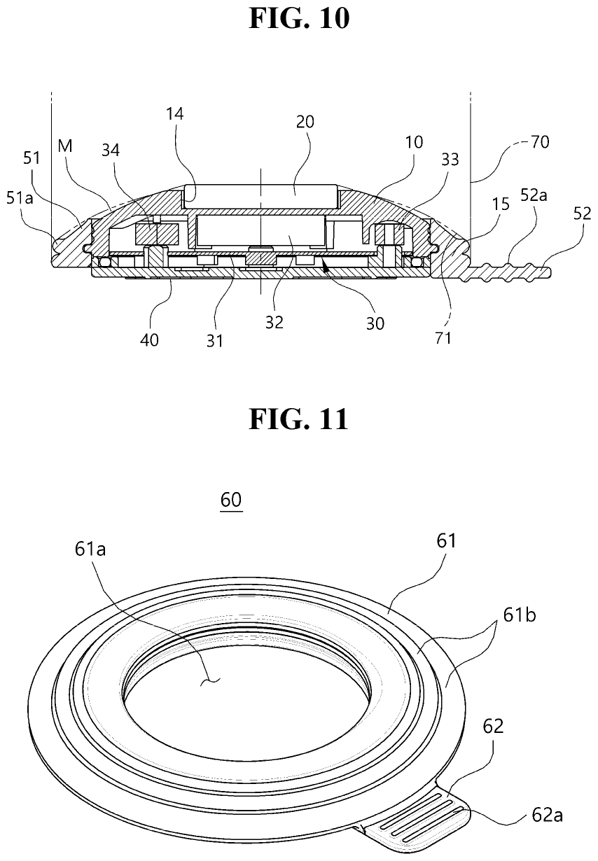

FIG. 10 is a view illustrating a state in which the warmer for a gas canister is coupled to a bottom of the first gas canister according to the exemplary embodiment of the present invention.

Referring to FIG. 10, the first cover 50 is not coupled to the warmer for a gas canister of the present invention, and the casing 10 is in direct contact with the bottom 71 of the first gas canister 70, such that the first gas canister 70 may be heated by heat generated by the heater 32.

The magnet 20 is provided on the casing 10, and the casing 10 may be easily attached to the first gas canister 70 by a magnetic force of the magnet 20. The casing 10 may be made of metal such as aluminum that is excellent in transferring heat, such that the heat of the heater 32 may be easily transferred to the first gas canister 70.

However, in case that the first cover 50 is not coupled to the warmer for a gas canister and the casing 10 is in direct contact with the bottom 71 of the first gas canister 70, a part of the casing 10 is in close contact with the bottom 71 of the first gas canister 70, and a part of the casing 10 is not in close contact with the bottom 71 of the first gas canister 70, such that the efficiency in transferring heat to the first gas canister 70 may deteriorate.

Therefore, the first cover 50 for the first gas canister 70 may be coupled to the casing 10 to maximize the efficiency in transferring heat to the first gas canister 70.

To maximize the efficiency in transferring heat to the first gas canister 70, the first cover 50 for the first gas canister 70 is coupled to the casing 10, and the heating medium M such as water is stored between the bottom 71 of the first gas canister 70 and the casing 10.

Specifically, the first gas canister 70 is reversed so that the bottom 71 is directed upward, and the heating medium M such as water is poured on the bottom 71. The casing 10 is coupled to the bottom 71 of the first gas canister 70 in a state in which the ring-shaped first cover 50 is coupled to the edge of the casing 10.

In the state in which the casing 10 is coupled to the bottom 71 of the first gas canister 70, the first gas canister 70 is reversed again so that the bottom 71 of the first gas canister 70 is directed downward. In this case, the heating medium M may be accommodated in the accommodation spaces 13 of the casing 10. Surface tension prevents the heating medium M accommodated in the accommodation spaces 13 from easily separating from the accommodation spaces 13.

The heating medium M may form a layer of water between the casing 10 and the bottom 71 of the first gas canister 70 and maximize a contact area between the casing 10 and the bottom 71 of the first gas canister 70. The heat of the heater 32 may be smoothly transferred to the first gas canister 70 through the casing 10 and the heating medium M, such that the efficiency in transferring heat to the bottom 71 of the first gas canister 70 may be maximized.

When the first cover 50 is coupled to the casing 10, a coupling groove 53 provided along an inner periphery of the first cover 50 is in close contact with and coupled to a coupling protrusion 15 provided at an edge of the casing 10 so that the coupling groove 53 and the coupling protrusion 15 are in close contact with each other, and the lateral protrusion 51a is in tight close contact with the bottom 71 of the first gas canister 70, which makes it possible to implement perfect watertightness.

The first cover 50 coupled to the casing 10 may be easily removed when the handle 52 is pulled.

Next, an operation of the second cover of the present invention will be described.

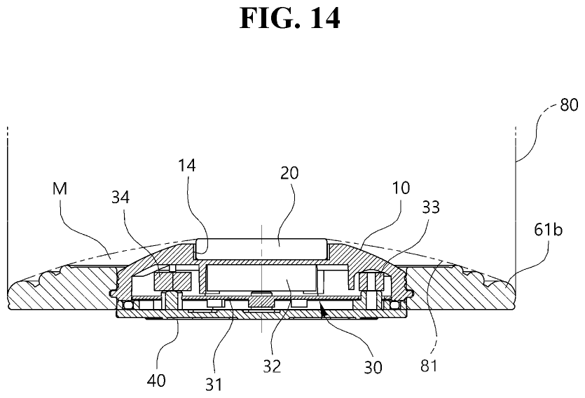

FIG. 14 is a view illustrating a state in which the warmer for a gas canister is coupled to a bottom of the second gas canister according to the exemplary embodiment of the present invention.

As illustrated in FIG. 14, the warmer for a gas canister of the present invention is manufactured to be suitable for the bottom of the first gas canister 70 that is the butane gas canister. Therefore, to use the warmer for the second gas canister 80 that is the isobutane gas canister having a larger size than the first gas canister 70, the second cover 60 for the second gas canister 80 may be coupled and used.

Specifically, the second gas canister 80 is reversed so that the bottom 81 is directed upward. The heating medium M such as water is poured on the bottom 81 of the second gas canister 80.

The casing 10 is coupled to the bottom 81 of the second gas canister 80 in the state in which the second cover 60 is coupled to the casing 10. In the state in which the casing 10 is coupled to the bottom 81 of the second gas canister 80, the second gas canister 80 is reversed again so that the bottom 81 of the second gas canister 80 is directed downward.

The heating medium M may be accommodated in the accommodation spaces 13 of the casing 10. Surface tension prevents the heating medium M accommodated in the accommodation spaces 13 from easily separating from the accommodation spaces 13.

The stored heating medium M may form a layer of water between the casing 10 and the bottom 81 of the second gas canister 80 to maximize the contact area between the casing 10 and the bottom 81 of the second gas canister 80. The heat of the heater 32 may be smoothly transferred to the bottom 81 of the second gas canister 80 through the casing 10 and the heating medium M, such that the efficiency in transferring heat to the second gas canister 80 may be maximized.

When the second cover 60 is coupled to the casing 10, a coupling groove 63 provided along an inner periphery of the second cover 60 is in close contact with and coupled to a coupling protrusion 15 provided at an edge of the casing 10 so that the coupling groove 63 and the coupling protrusion 15 are in close contact with each other, and any one of the plurality of stepped portions 61b is in tight close contact with the bottom 81 of the second gas canister 80 regardless of a size of the bottom 81 of the second gas canister 80, which makes it possible to implement perfect watertightness.

The second cover 60 coupled to the casing 10 may be easily removed when the handle 62 is pulled.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A warmer for a gas canister, the warmer comprising:
a casing having a curved surface corresponding to a bottom of a gas canister and having a structure with an open bottom;
a magnet provided on an outer portion of the casing and configured to be attachable to the bottom of the gas canister;
a heat generator provided in the casing and configured to transfer heat to the gas canister; and
a bottom cover coupled to the bottom of the casing in a state in which the heat generator is mounted in the casing.

2. The warmer of claim 1, wherein a plurality of circular heat radiating fins is provided on the outer portion of the casing and configured to define concentric circles, a radial heat radiating fin is provided on the outer portion of the casing and intersects the circular heat radiating fins, and an accommodation space capable of accommodating a heating medium is defined by a structure in which the radial heat radiating fin intersects the circular heat radiating fin.

3. The warmer of claim 1, wherein the heat generator comprises:
a printed circuit board;
a heater connected to the printed circuit board and configured to transfer heat to the casing; and
a temperature sensor connected to the printed circuit board.

4. The warmer of claim 3, wherein the heat generator further comprises:
a bimetal switch connected to the printed circuit board and spaced apart from the casing, and
wherein the bimetal switch cuts off a supply of power when a temperature of air in the casing is higher than a preset temperature.

5. The warmer of claim 1, wherein the gas canister is a first gas canister or a second gas canister, and
wherein the casing is in close contact with a bottom of the first gas canister in a state in which a first cover is coupled, or the casing is in close contact with a bottom of the second gas canister in a state in which a second cover is coupled.

6. The warmer of claim 5, wherein the first gas canister is a butane gas canister, the second gas canister is an isobutane gas canister, and the first and second covers are each a silicone cover.

7. The warmer of claim 5, wherein a heating medium is stored between a bottom of the first gas canister and the casing or stored between the bottom of the second gas canister and the casing.

8. The warmer of claim 7, wherein the first cover comprises:
a ring-shaped main body configured to surround an edge of the casing and coupled to the bottom of the first gas canister so that an outer surface of the main body is in close contact with the bottom of the first gas canister to implement watertightness; and
a handle extending from one side of the main body.

9. The warmer of claim 7, wherein the second cover comprises:
a main body having a through-hole at a center thereof and configured such that the remaining portion of the main body, except for the through-hole, surrounds the casing, the main body having a curved surface corresponding to the bottom of the second gas canister; and
a handle extending from one side of the main body.

10. The warmer of claim 9, wherein the main body has a plurality of stepped portions disposed between the through-hole and an edge of the main body and configured to define concentric circles having stepped shapes, and
wherein the stepped portion is in close contact with the bottom of the second gas canister to implement watertightness.
